(19) United States
(12) Patent Application Publication
(10) Pub. No.: US 2025/0007098 A1
(43) Pub. Date: Jan. 2, 2025

(54) MULTI-LAYER ELECTRODE FOR BATTERY

(71) Applicant: FORD GLOBAL TECHNOLOGIES, LLC, DEARBORN, MI (US)

(72) Inventors: Zijie Lu, Novi, MI (US); Minghong Liu, Northville, MI (US); Celia Cunningham, Detroit, MI (US)

(21) Appl. No.: 18/342,224

(22) Filed: Jun. 27, 2023

(51) Int. Cl. H01M 50/46; H01M 4/66; H01M 50/431; H01M 50/44

(52) U.S. Cl. CPC H01M 50/46; H01M 4/667; H01M 4/668; H01M 50/431; H01M 50/44

(57) ABSTRACT

The present disclosure relates to a secondary solid-state battery. This battery includes a current collector, comprising a poly 3,4-ethylenedioxythiphene polystyrene sulfonate (PEDOT-PSS) layer, which is in direct areal contact with a negative electrode. The battery also includes a positive electrode and a solid electrolyte separator between the positive and negative electrodes. The PEDOT-PSS layer can compress and expand in response to the expansion and contraction of the negative electrode. In some embodiments, the current collector may include a carrier film onto which the PEDOT-PSS layer is coated. A cell stack of multiple assemblies further comprises the positive electrode, solid electrolyte separator, negative electrode, and current collector with some adjacent pairs separated by carbon fiber papers.

### TECHNICAL FIELD

This disclosure pertains to solid-state batteries (SSBs), and in particular, to mitigating issues associated with volume change during battery charge and discharge in SSBs, especially those employing metallic anodes like lithium (Li) or silicon (Si).

### BACKGROUND

SSBs may provide increased specific energy density and volumetric energy density. The utilization of metallic anodes such as Li or Si in SSBs has been helpful in attaining these energy density metrics. These anodes sometimes present challenges due to the substantial volume change they undergo during charge and discharge cycles.

To maintain interfacial contact within cells and compensate for these volume changes, stack pressures in the range of 5-50 MPa are typically required. Despite this, performance degradation with Li- or Si-based SSBs is still possible. This issue is partly attributed to stress fluctuation and associated strain accumulation in the electrodes during operation.

### SUMMARY

This disclosure outlines a secondary SSB design that integrates a current collector, a poly 3,4-ethylenedioxythiphene polystyrene sulfonate (PEDOT-PSS) layer, with the negative electrode. The negative electrode is coated onto this PEDOT-PSS layer, which is structured to expand and contract in response to the respective expansion and contraction of the negative electrode, thereby managing the strain involved in the operation of the battery.

The positive electrode and the negative electrode are separated by a solid electrolyte separator in the proposed battery configuration. The current collector can be further enhanced by adding a carrier film on which the PEDOT-PSS layer is coated, adding to the mechanical integrity of the current collector.

This carrier film can be a polyimide substrate, offering insulation and structural benefits to the overall battery design. The composition of the positive electrode, the solid electrolyte separator, the negative electrode, and the current collector creates an electrode assembly.

The disclosure further introduces a secondary SSB composed of several such electrode assemblies. Each assembly includes positive and negative electrodes, a solid electrolyte separator, and a current collector in direct areal contact with the negative electrode, positioning the negative electrode between the solid electrolyte separator and the current collector.

In addition to these elements, the described battery configuration can incorporate carbon fiber papers interleaved with the electrode assemblies. These carbon fiber papers act as additional spacers and stabilizers, such that not all neighboring pairs of electrode assemblies are in direct contact. Some are separated by one of these carbon fiber papers.

In another secondary SSB embodiment, the battery includes positive and negative electrodes, a solid electrolyte separator, and a current collector formed by a PEDOT-PSS layer coated on a carrier film. The carrier film is in direct areal contact with the negative electrode, with the negative electrode situated between the solid electrolyte separator and the current collector. The carrier film can be a polyimide substrate in this design, adding a layer of structural integrity to the battery.

### BRIEF DESCRIPTION OF THE DRAWINGS

FIG. 1A is a schematic cross-section of a current collector comprising carbon fiber paper;

FIG. 1B is a schematic cross-section of an anode coating on a current collector;

FIG. 2A is a schematic cross-section of a single cell arrangement with a carbon fiber paper current collector;

FIG. 2B is a schematic cross-section of a cell stack arrangement with a carbon fiber paper current collector;

FIG. 3 is a schematic cross-section of carbon fiber paper as a strain buffer in a secondary SSB cell stack;

FIG. 4 is a schematic cross-section of an elastic material sandwiched between two metal foils;

FIG. 5 is a schematic cross-section of a microporous layer coated metal foam; and

FIG. 6 is a schematic cross-section of a conductive polymer current collector in a secondary SSB cell.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Measures that can mitigate stress fluctuation, ease strain accumulation, and reduce the need for stack pressure are desirable. Such measures could enhance cycle stability and battery life, representing a significant advancement in battery technology. The disclosed embodiments may mitigate the challenges associated with volume change in SSBs. They introduce an elastic and conductive layer that can serve as the current collector or a separate strain buffer. This layer can be used in SSBs that display significant volume change during charge and discharge, such as those based on metallic anodes, like Li metal and Si.

The electrical conductivity of this layer should exceed 1 S/cm, ideally surpassing 10 S/cm. To accommodate the SSB anode volume change, the elasticity of the layer should be able to compensate for strains, for instance, a strain of 40% at a compressive stress of 1.5 MPa. Ideally, the layer should have a compressive elastic modulus ranging between 1 and 10 MPa, and a strain range (up to 60%). The layer's thickness should be small, ideally less than 80 micrometers in an uncompressed state.

In one embodiment carbon fiber paper may be used as the current collector. A microporous layer, composed of nano-sized carbon particles, is coated on the carbon fiber paper to ensure a smooth surface for coating electrode, for example, the Si anode layer.

In another embodiment a metal foam can be used as the main elastic component, with a microporous (carbon) layer coated on top of it to tune the surface roughness and enhance the electrical contact. The elastic properties of the metal foam can be engineered as desired. A microporous layer, composed of nano-sized carbon particles, is used to ensure a smooth surface for coating the Si anode layer.

In another embodiment, a sandwich configuration of elastic material between two metal layers in contemplated. In this design, an elastic material (like silicone rubber) is sandwiched between two metal foils. The metal foils provide electrical connection, and the spring-like middle layer contracts when the electrode expands, thereby releasing the strain of electrode active materials. When the active materials contract, the layer rebounds to keep the particles in tight contact. The elastic material's properties, such as the elastic modulus and thickness, can be tailored to meet the expanding and contracting requirements. The metal foil's thickness could be in the 2˜5 μm range to minimize the total thickness of the current collector. The metal foils could be the same metal (such as Cu foils or Al foils) or different metals (one side could be a Cu foil, the other side an Al foil).

These elastic and conductive layers can not only be used as the direct replacement of the metal foil current collectors in present battery manufacturing (i.e., copper foil on anode and aluminum foil on cathode), but also be used as a strain buffer layer between single cells. The latter may be more cost effective for the case of the SSB electrode which displays smaller volume changes during charge and discharge. The number of such strain buffer layers and the locations of them need to be carefully considered to have the optimal performance and minimal cost increase.

The disclosure pertains to cycle stability, thus increasing the lifespan of metallic anode based SSBs. Another potential benefit of the disclosure is the reduction of operating stack pressure, which is currently challenging for battery packaging in electric vehicles. This disclosure has the potential to lower the stack pressure to less than 1 MPa, thus simplifying the battery packaging.

Moreover, the contemplated embodiments do not increase battery manufacturing complexity. For instance, the new current collector is a direct replacement for the current metal foil in the roll-to-roll process. The strain buffer layer can be readily inserted between the single cells.

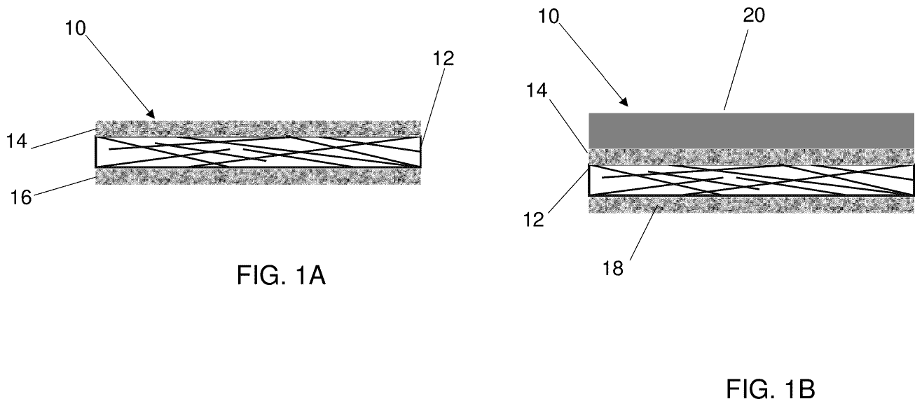

FIG. 1A provides an illustrated embodiment of the carbon fiber paper. This carbon fiber paper, denoted as numeral 10, is a composite structure, comprising a core carbon fiber layer 12 encapsulated between two microporous layers, denoted by numerals 14 and 16 respectively. The microporous layers, 14 and 16, comprise a multitude of nano-sized carbon particles 18, which are effectively embedded within them. The typical thickness of the microporous layer is in the range of 1-10 um.

The presence of these microporous layers 14, 16 on both sides of the carbon fiber layer 12 not only contribute to the enhanced mechanical stability of the carbon fiber paper 10 but also serve to render its surface smoother. This enhanced surface smoothness is advantageous when subsequent coating of a Si anode layer is undertaken, aiding in adhesion and uniform coverage of the layer.

In one embodiment, the carbon fiber paper 10 operates as the current collector within the construct of an SSB. In this function, it is configured such that one of the microporous layers, say 14, is in direct areal contact with a negative electrode, whereas the other microporous layer, say 16, is in direct areal contact with a negative electrode or positive electrode. The outcome of this arrangement ensures that the surfaces of the current collector are smoother than the surfaces of a constituent carbon fiber.

Transitioning to FIG. 1B, the process of coating a Si anode slurry, denoted as numeral 20, onto the carbon fiber paper 10 is depicted. Once applied, the Si anode slurry 20 assumes the role of the negative electrode.

Notably, the incorporation of nano-sized carbon particles 18 within the microporous layers 14, 16, serves to enhance conductivity and promote efficient electron transfer within the battery. In certain embodiments, the carbon fiber layer 12 could take the form of a metal foam, such as Cu or Al. The dimensions of this metal foam layer could be such that its thickness exceeds that of each of the microporous carbon layers 14, 16.

Following the coating process, the solid electrolyte separator is applied, such that it directly contacts the Si anode 20. Furthermore, in some configurations, a positive electrode may be introduced into the battery structure, arranged so that it is in direct areal contact with the solid electrolyte separator on the other side.

This outlined configuration forms an integrated cell assembly comprising the positive electrode coated on a current collector, which can be the carbon fiber paper 10, the solid electrolyte separator, and the negative electrode, which can be applied as a Si slurry on a current collector. Multiple such cell assemblies, along with carbon fiber papers, can be assembled in an interleaved manner. Adjacent pairs of the electrode assemblies can be separated by one of the carbon fiber papers.

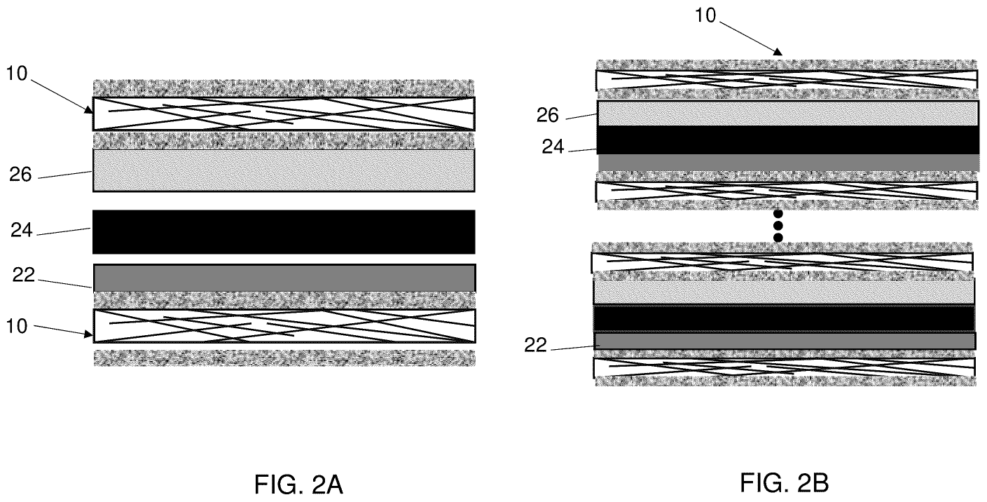

Continuing onto FIG. 2A, a battery cell structure in the mentioned embodiment is illustrated. The battery cell comprises the carbon fiber paper 10 as the base layer. Over this base layer, a Si anode layer 22 is deposited, representing the negative electrode in this battery cell structure. The Si anode layer 22 directly interfaces with the microporous layer 14 of the carbon fiber paper 10, benefiting from the smoother surface provided by the microporous layer.

Following the Si anode layer 22, a solid electrolyte separator 24 is applied, which directly interfaces with the Si anode layer 22. The solid electrolyte separator 24 facilitates ion transport between the battery's electrodes while preventing direct electronic contact between them.

Atop the solid electrolyte separator 24, a cathode layer 26 is applied, forming the positive electrode of the battery cell structure. The complete structure is then finished with a current collector, forming a single battery cell. The presently commonly used aluminum foil can be used as the cathode current collector. A carbon fiber paper current collector 10 can also be used for the cathode. This configuration represents a coherent cell assembly, integrating a positive electrode (cathode layer 26), a solid electrolyte separator 24, and a negative electrode (Si anode layer 22).

Transitioning to FIG. 2B, it presents an embodiment of the bipolar arrangement of the battery cells. Here, another complete battery cell structure, similar to the one in FIG. 2A, is stacked over the existing structure. Each cell in the stack maintains the same order of layers as a single cell, starting with carbon fiber paper current collector 10 at the base, followed by a Si anode layer 22, a solid electrolyte separator 24, and a cathode layer 26, then repeat the structure. In the end the battery cell can be completed with a carbon fiber paper 10.

This bipolar stacking design allows for enhanced energy density by allowing the series connection of multiple cells. The bipolar configuration permits both anodes and cathodes to share current collectors, reducing the total weight and volume of the battery, leading to a more compact and efficient design. As a result, such a design accommodates multiple electrode assemblies and carbon fiber papers in an interleaved manner, where only some adjacent pairs of the electrode assemblies are separated by one of the carbon fiber papers. This compact arrangement of layers in the bipolar configuration optimizes the battery's performance and efficiency.

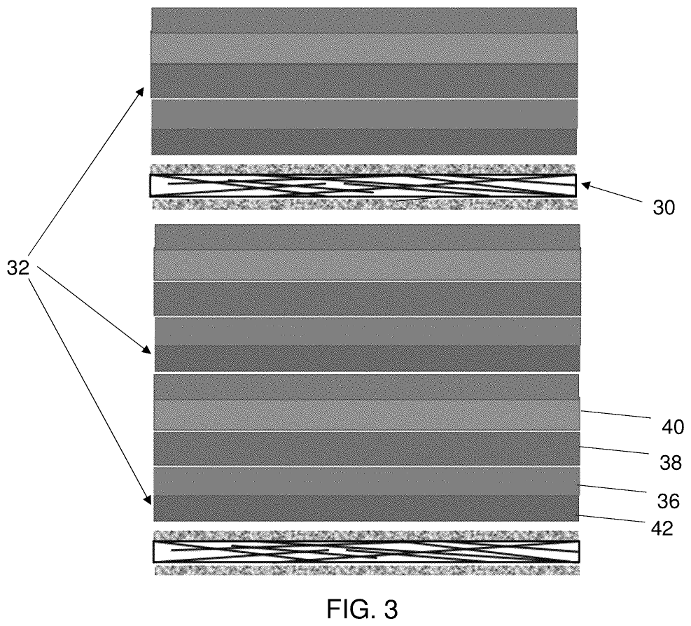

The elastic and conductive carbon fiber structure not only can be used as current collector, but also can be used as a strain buffer layer. Referring now to FIG. 3, an expanded battery stack is illustrated. The configuration begins with a carbon fiber paper, denoted as numeral 30, serving as the base layer. This layer is followed by two or more single battery cells, denoted as numeral 32. Each of these single cells 32 includes several components: a Si anode 34, a solid electrolyte separator 36, a cathode 38, and a substrate layer. The cathode substrate can be an aluminum (Al) foil 40, and the anode's substrate can be a Cu foil 42. Upon these components, another layer of the carbon fiber paper 30 is placed, followed by a subsequent single cell 32.

In this particular arrangement, the Si anode 34 is coated on the Cu foil 42, following conventional battery manufacturing techniques. However, what differentiates this structure is the integration of the carbon fiber paper 30 as a strain buffer layer. This layer's role is to help dissipate mechanical stresses, promoting the overall durability and longevity of the battery cell.

Notably, it is not necessary to include the carbon fiber paper 30 for every single cell 32. Depending on experimental determinations and the desired properties of the battery, this layer might be included after every 3 to 5 single cells, for instance. The exact placement will be determined based on experimental results. By reducing the number of carbon fiber papers 30 in the stack, the configuration becomes more compact, thus enhancing the volumetric energy density of the battery.

The complete structure represents a secondary SSB. It incorporates several electrode assemblies, each of which includes positive and negative electrodes, a solid electrolyte separator 36 situated between the positive and negative electrodes, and a current collector in direct areal contact with the negative electrode. In this design, the negative electrode (Si anode 34) is lodged between the solid electrolyte separator 36 and the current collector (carbon fiber paper 30).

The secondary SSB configuration also employs carbon fiber papers 30 interleaved with the electrode assemblies. In this layout, some but not all adjacent pairs of the electrode assemblies are separated by one of the carbon fiber papers 30.

In an additional aspect of the depicted embodiment, the current collector can incorporate a carrier film to support the structural integrity and better adhesion with the negative electrode. A viable choice for this carrier film could be a polyimide substrate due to its mechanical and thermal stability. This polyimide substrate could be coated with a layer of poly 3,4-ethylenedioxythiophene polystyrene sulfonate, a conductive polymer, to boost the current collection capacity of the current collector.

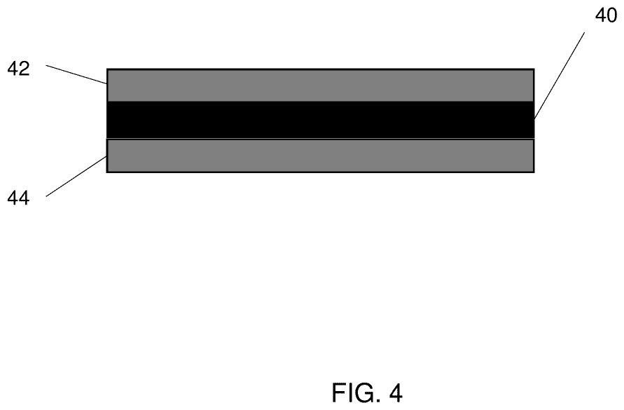

Shifting now to FIG. 4, which presents a configuration of an elastic material 40 enveloped between two metal foils 42 and 44. Specifically, in this configuration, an elastomeric material, such as silicone rubber, is utilized as the central layer, creating a resilient structure that is adaptable to the expanding and contracting behavior of the battery components.

The role of the metal foils 42 and 44 is multifaceted. Primarily, they serve as conduits providing electrical connection. Additionally, they act in conjunction with the elastic material 40 to form a compressible structure. This “spring-like” middle layer is designed to contract when the electrode expands during charge cycles, thereby releasing strain experienced by the electrode active materials. Conversely, it bounds back or expands when the active material shrinks during discharge cycles, ensuring the particles remain in tight contact.

These adaptive behaviors are helpful for maintaining the integrity of the battery, enhancing its durability and performance. It should be noted that the properties of the elastic material 40, such as its elastic modulus and thickness, can be precisely engineered to meet the specific expanding and contracting requirements of the battery.

In order to maintain the compact design of the battery and minimize the total thickness of the current collector, the thickness of the metal foils 42 and 44 can be kept within the 2˜5 um range. This careful balance ensures the battery retains its energy density while incorporating the strain-relief benefits of the elastic layer 40.

Depending on the design needs and performance requirements, the metal foils 42 and 44 can be made from the same material or different materials. In some configurations, both could be Cu, Al, or any other conductive material that suits the application requirements. In other instances, the metal foils might consist of different materials to optimize certain properties, such as conductivity, mechanical strength, or corrosion resistance.

A secondary SSB configuration incorporates this current collector design with an elastomeric material sandwiched between two metal foils. In this configuration, the negative electrode and the positive electrode are separated by a solid electrolyte separator, and each of the metal foils of the current collector is in direct areal contact with a positive or negative electrode.

The entire configuration consisting of the positive and negative electrodes, solid electrolyte separator, and the uniquely designed current collector forms an electrode assembly. The battery can further comprise a plurality of these electrode assemblies and carbon fiber papers interleaved with the electrode assemblies. This arrangement ensures that some but not all adjacent pairs of electrode assemblies are separated by one of the carbon fiber papers, enhancing the mechanical stability and performance of the battery.

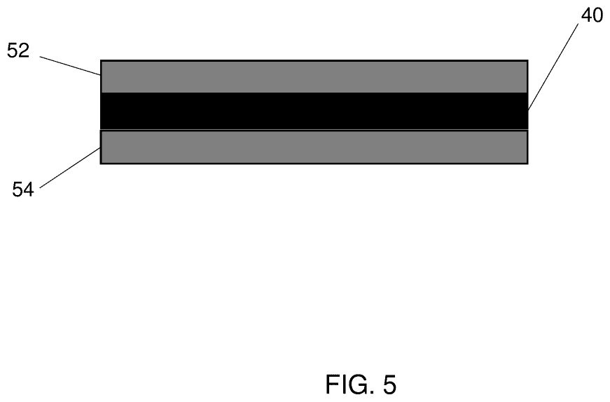

Turning now to FIG. 5, a novel design configuration is presented. Here, a metal foam 50 serves as the primary elastic component, enveloped by two microporous layers 52 and 54. These microporous layers are comprised of nano-sized carbon particles and offer a number of functionalities to the overall system.

The microporous layers 52 and 54 serve as a vital interface, contributing to both the mechanical and electrical properties of the assembly. They function to tune the surface roughness of the metal foam 50, creating a more even and conducive surface. This smooth surface becomes ideal for the subsequent coating of the Si anode layer, aiding in the enhancement of its adhesion and uniformity. The microporous layers 52 and 54 also play a pivotal role in enhancing electrical contact, contributing to conductivity within the assembly.

The metal foam 50 at the core of this design has been chosen due to its inherent elasticity. This elasticity allows it to respond to the expansion and contraction of the electrodes during the charge-discharge cycles of the battery, thus enhancing durability and reliability. The elastic properties of this metal foam 50 can be carefully engineered to meet the desired specifications, ensuring optimal performance in response to the active material's mechanical behavior.

The described configuration is integrated into a secondary SSB in which a current collector comprises this metal foam 50 sandwiched between the microporous layers 52 and 54. The positive electrode and the negative electrode are separated by a solid electrolyte separator, and each of the microporous layers of the current collector is in direct areal contact a positive or negative electrode.

The entirety of this assembly-comprising the positive and negative electrodes, the solid electrolyte separator, and the uniquely designed current collector-forms a cell assembly. The battery design may include multiple such cell assemblies. Further, carbon fiber papers may be interleaved with these assemblies such that not all adjacent pairs of electrode assemblies are in direct contact. Instead, some are separated by a carbon fiber paper, providing additional mechanical stability and enhancing the battery's overall performance.

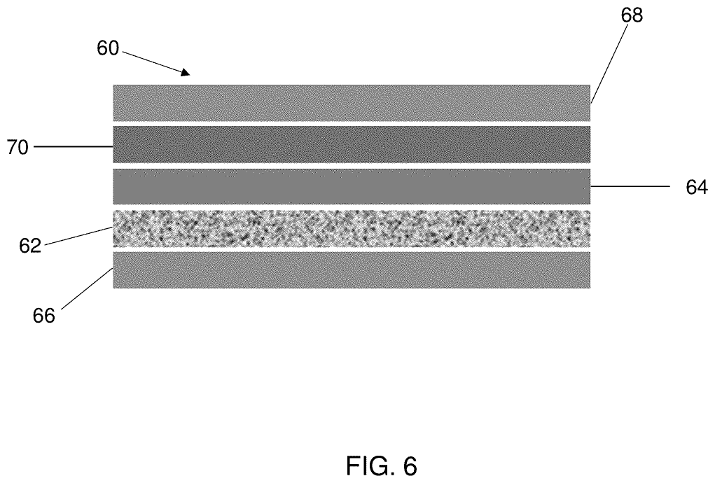

Referring now to FIG. 6, a secondary SSB cell configuration 60 is introduced. In this embodiment, a strain buffer layer and current collector in one, a poly 3,4-ethylenedioxythiphene polystyrene sulfonate (PEDOT-PSS) layer 62, forms a fundamental component. The anode layer 64, which can be a Si anode can be coated directly on this PEDOT-PSS layer.

The PEDOT-PSS layer 62 is itself coated on a carrier film 66, such as an insulating polyimide substrate. This polyimide substrate serves to provide structural support to the PEDOT-PSS layer 62, enhancing the overall mechanical stability of the SSB cell 60.

However, this carrier film 66 can either be retained or removed in the SSB stack, depending on the specific battery configuration. For example, it might be removed in a bipolar stack configuration to optimize for space and material efficiency.

To further increase the mechanical strength of the conductive polymer current collector (PEDOT-PSS) 62, the layer may be reinforced with other porous substrates or polymer materials. These could include expanded polytetrafluoroethylene (e-PTFE), glass fibers, cellulose substrate, or polyvinylidene fluoride-hexafluoropropylene (PVDF-HFP), amongst other options. These reinforcements ensure that the current collector is robust and able to endure the mechanical stresses experienced during battery operation.

The SSB cell 60 as a whole consists of a positive electrode 68, a solid electrolyte separator 70, a negative electrode 64, and the current collector 62. The current collector 62, containing the PEDOT-PSS layer, is in direct areal contact with the negative electrode 64. The negative electrode 64, in turn, is positioned between the solid electrolyte separator 70 and the current collector 62.

The arrangement comprising the positive electrode 68, the solid electrolyte separator 70, the negative electrode 64, and the current collector 62 forms a cell assembly. These assemblies can be used to create a secondary SSB comprising multiple such assemblies. Furthermore, carbon fiber papers can be interleaved with these assemblies such that not all adjacent pairs of electrode assemblies are in direct contact. Instead, some are separated by a carbon fiber paper, offering additional mechanical stability and enhancing the battery's overall performance.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A secondary solid-state battery comprising:
a current collector including a poly 3,4-ethylenedioxythiphene polystyrene sulfonate layer;
a negative electrode coated on the poly 3,4-ethylenedioxythiphene polystyrene sulfonate layer such that, responsive to expansion and contraction of the negative electrode, the poly 3,4-ethylenedioxythiphene polystyrene sulfonate layer is configured to compress and expand respectively;
a positive electrode; and
a solid electrolyte separator between the positive and negative electrodes.

2. The secondary solid-state battery of claim 1, wherein the current collector further includes a carrier film.

3. The secondary solid-state battery of claim 2, wherein the carrier film is a polyimide substrate.

4. The secondary solid-state battery of claim 2, wherein the poly 3,4-ethylenedioxythiphene polystyrene sulfonate layer is coated on the carrier film.

5. The secondary solid-state battery of claim 1, wherein the positive electrode, the solid electrolyte separator, negative electrode, and current collector form an electrode assembly, further comprising a plurality of the electrode assemblies and carbon fiber papers interleaved with the electrode assemblies.

6. The secondary solid-state battery of claim 5, wherein the carbon fiber papers are interleaved with the electrode assemblies such that some but not all adjacent pairs of the electrode assemblies are separated by one of the carbon fiber papers.

7. A secondary solid-state battery comprising:
a plurality of electrode assemblies, each of the electrode assemblies including positive and negative electrodes, a solid electrolyte separator between the positive and negative electrodes, and a current collector in direct areal contact with the negative electrode such that the negative electrode is between the solid electrolyte separator and current collector; and
carbon fiber papers interleaved with the electrode assemblies such that some but not all adjacent pairs of the electrode assemblies are separated by one of the carbon fiber papers.

8. The secondary solid-state battery of claim 7, wherein the current collector includes a poly 3,4-ethylenedioxythiphene polystyrene sulfonate layer.

9. The secondary solid-state battery of claim 8, wherein the current collector further includes a carrier film.

10. The secondary solid-state battery of claim 9, wherein the carrier film is a polyimide substrate.

11. The secondary solid-state battery of claim 10, wherein the poly 3,4-ethylenedioxythiphene polystyrene sulfonate layer is coated on the carrier film.

12. A secondary solid-state battery comprising:
positive and negative electrodes;
a solid electrolyte separator between the positive and negative electrodes; and
a carrier film and poly 3,4-ethylenedioxythiphene polystyrene layer coated on the carrier film to form a current collector in direct areal contact with the negative electrode such that the negative electrode is between the solid electrolyte separator and current collector.

13. The secondary solid-state battery of claim 12, wherein the carrier film is a polyimide substrate.

14. The secondary solid-state battery of claim 12, wherein the positive electrode, the solid electrolyte separator, negative electrode, and current collector form an electrode assembly, further comprising a plurality of the electrode assemblies and carbon fiber papers interleaved with the electrode assemblies.

15. The secondary solid-state battery of claim 14, wherein the carbon fiber papers are interleaved with the electrode assemblies such that some but not all adjacent pairs of the electrode assemblies are separated by one of the carbon fiber papers.
